(19) United States
(12) Patent Application Publication
(10) Pub. No.: US 2015/0366400 A1
(43) Pub. Date: Dec. 24, 2015

(54) BAKE DIVIDES BAKING PAN DIVIDER ISNERT

(71) Applicant: Deborah Riddy, New York, NY (US)

(72) Inventor: Deborah Riddy, New York, NY (US)

(21) Appl. No.: 14/742,999

(22) Filed: Jun. 18, 2015

Related U.S. Application Data
(60) Provisional application No. 62/013,804, filed on Jun. 18, 2014.

(51) Int. Cl. A47J 36/16; A47J 37/01

(52) U.S. Cl. CPC A47J 36/16; A47J 37/01

(57) ABSTRACT

A baking pan insert for dividing the contents of a baking pan including a fixed insert and an adjustable insert comprising slotted dividiers.

### CLAIM OF PRIORITY

This patent application claims priority under 35 USC 119 (e) (1) from U.S. Provisional Patent Application Ser. No. 62/013,804 filed Jun. 18, 2014, of common inventorship herewith entitled, “Bake Divides,” which is incorporated herein by reference as though the same were set forth in its entirety.

### BACKGROUND OF THE INVENTION

1. Field of the Invention

This invention relates generally to bake divides and, more particularly, the invention relates to bake divides for dividing baking pans to facilitate the cooking of multiple separate food items in one receptacle.

2. Description of the Prior Art

A staple in virtually every household, the conventional oven is a common kitchen appliance that is used for baking, broiling, roasting, and heating food. Food normally cooked in this manner includes meat, casseroles, and baked goods such as bread, cake, and other desserts. With its multiple applications, the oven is essential for creating everything from large family meals to simply warming leftovers from the previous night. Regardless of the food item prepared, household cooks have a plethora of specially designed baking pans at their disposal to accommodate any desired treat. From non-stick cookware such as circular, square, and rectangular cake and bread pans and flat, heavy gauge cookie sheets to glass roasters and pie pans, these cooking accessories allow certain foods to be prepared to perfection. However, for most household cooks, baking is not an everyday occurrence, with many only utilizing the oven and cookware on special occasions such as birthdays and holidays. As a result, these consumers find themselves spending inordinate amounts of money on baking pans that will only be used perhaps once a year. Additionally, finding ample storage space for a large collection of bakeware can prove challenging. Add in plates, bowls, and saucers, all squeezed in cabinets to maximize all available space, baking pan storage becomes an almost impossible endeavor. Not limited to between-use placement problems, large and bulky pans can also be difficult to manage during the baking process. With little room in small ovens for more than one pan, occasional bakers find themselves having to bake one item at a time, a frustrating procedure particularly when time is of the essence.

### SUMMARY OF THE INVENTION

It is an object of the present invention to provide a baking pan insert capable of bisecting a baking pan to accommodate the preparation of two different foods in the same baking pan.

It is a further object of the present invention to provide a baking pan insert capable of dividing a baking pan to accommodate the preparation of multiple foods in the same baking pan.

It is a still further object of the present invention to provide a baking pan insert capable of dividing a baking pan to accommodate the preparation of multiple individual servings of food in the same baking pan.

### BRIEF DESCRIPTION OF THE DRAWINGS

FIG. 1 is a perspective view illustrating bake divides configured in an “H” shape to divide a rectangular pan into two equal parts, constructed in accordance with the present invention.

FIG. 2 is a perspective view illustrating bake divides configured t in a ladder shape to divide a rectangular pan into three equal parts, constructed in accordance with the present invention.

FIG. 3 is a perspective view illustrating a cake pan divided into two equal parts, with each part having a different cake.

### DETAILED DESCRIPTION OF THE PREFERRED EMBODIMENTS

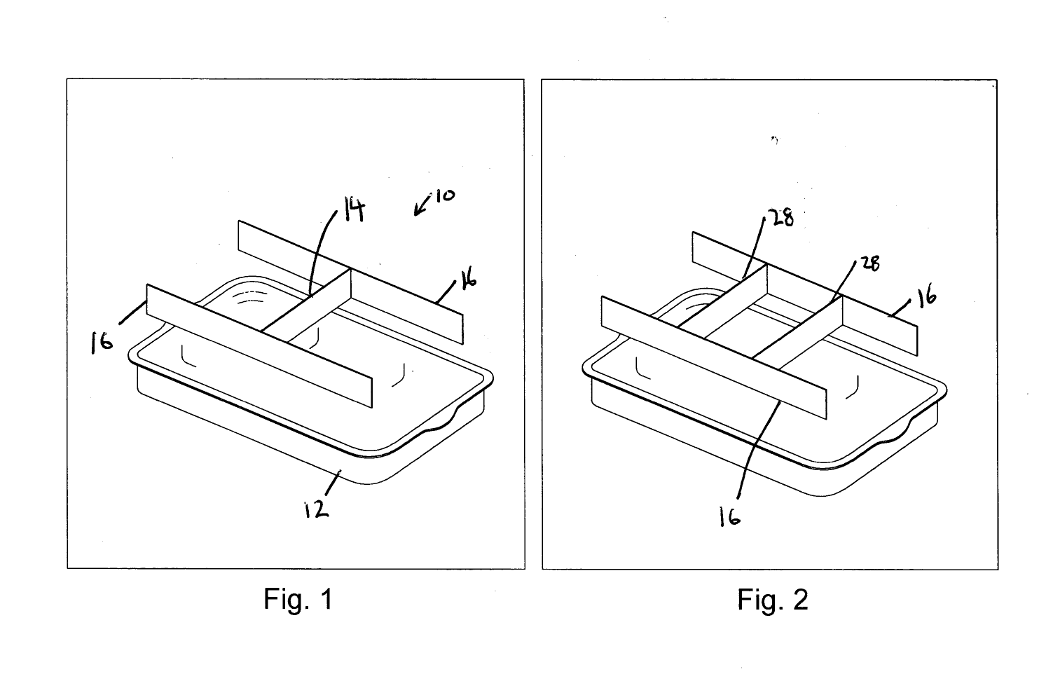

As illustrated in FIGS. 1-3, the present invention is bake divides for dividing baking pans in sections, facilitating the cooking of multiple separate food items in one receptacle.

The present invention, bake divides baking pan divider insert, or simply bake divides, is manufactured from any suitable heat-resistant material including plastic, aluminum or other flexible metal.

FIG. 1 shows one embodiment of the bake divides designed to divide the baking portions of a rectangular pan 12 into two equal portions, by separating the contents of the pan 12 along its long side. The unit 10 is in the form of an “H,” with a horizontal centerpiece 14 which bicepts two parallel equidistant sides 16 at the center of the parallel equidistant sides. The height of the bake divides is appropriate to accommodate the depth of the baking pan. For a typical 9×13 inch pan, the height of the bake divides measures approximately one and one quarter inches (1¼; the widths of the divides vary according to the size of the baking pan in which they are used. FIG. 3 shows the pan of FIG. 1 having one cake on the first side 22, and a different cake on the second side 24.

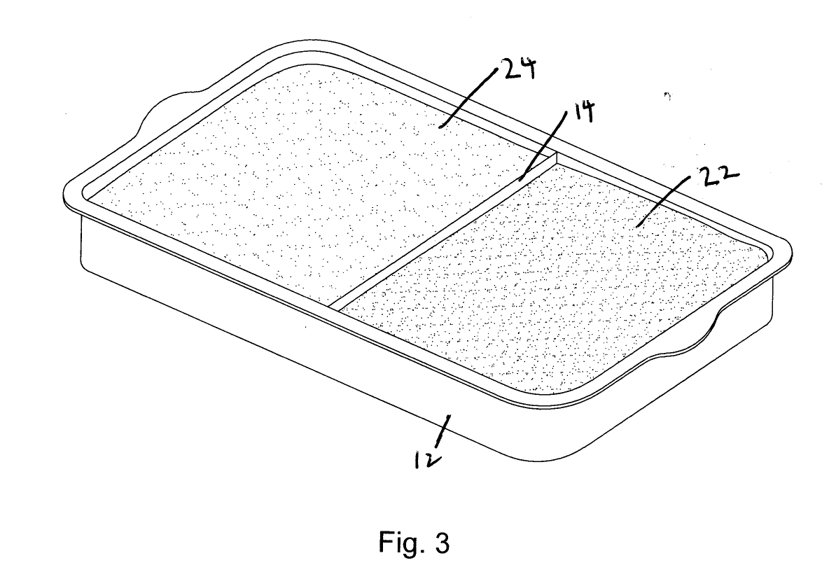

FIG. 2 shows an additional embodiment, in the form of a ladder having two rungs 28, which are perpendicular to sides 16, which is useful for creating three approximately equal portions.

Another embodiment, not shown, is in the form of a “#” is useful for creating nine portions.

In an alternative embodiment, the dividers are slotted and can be used to create any number of servings, such as 6, 8, 12, 24 and 24 slots, for example. The dividers can be slotted by cutting a series of spaced apart slots, wherein the cut extends from one edge of the divider to half way through the height of a first divider. These slots can correspond to similar slots on a second divider perpendicularly oriented to the first divider. Thus, bake divides can be adjustable for all baking pan configurations, including residential as well as commercial applications. As can be imagined, the bake divides size offerings could be virtually limitless.

Relatively simple in design yet extremely effective in intended application, use of the bake divides are very easy and straightforward. First, the user selects the appropriate bake divide insert for the job at hand. By way of example, when using a 13×9 rectangular pan, an insert that is roughly nine inches in width is appropriate. Next, the bake divide is placed in the very center of the pan, effectively dividing the bakeware in two equal halves. The user then pours batter or dough into the pan on each side of the divide, and place the pan in the oven. When the food is finished baking, the user pulls out the pan to reveal multiple identical baked goods, all from the same pan. If desired, the same procedure can be used for making more than two items; variable inserts are simply placed in the pan, creating smaller but more numerous creations from the one piece of bakeware.

There are several significant benefits and advantages associated with the bake divides of the present invention. Foremost, the bake divides provide household consumers with a simple yet effective means of maximizing baking output while minimizing cost, time, and space. A line of handy inserts that section off baking pans into two (or more), the divides eliminate the need to purchase a collection of expensive bakeware. In this manner, users only require one dish to bake a veritable collection of goods. The bake divides prove especially ideal for those who only bake during special occasions, since they are able to easily and expediently bake in bulk without having to worry about collecting multiple pans that would hardly see the inside of an oven. At the same time, the bake divides save valuable storage space in the kitchen, freeing limited cabinet room for other necessary items such as dishes, or even cleaning supplied. Perhaps most importantly, the divides facilitate baking production, allowing users to prepare multiple products in roughly half the time. As a result, home bakers spend less time in the kitchen and more time celebrating with loved ones. While the bake divides were primarily conceived with household users in mind, professional bakers and restaurant cooks would certainly benefit from the time- and space-saving qualities afforded by this versatile product line.

An innovative product invention, the bake divides readily enhance the preparation of a variety of foods. An easy-to-use set of cookware accessories, the divides provide invaluable additions to any kitchen.

The foregoing exemplary descriptions and the illustrative preferred embodiments of the present invention have been explained in the drawings and described in detail, with varying modifications and alternative embodiments being taught. While the invention has been so shown, described and illustrated, it should be understood by those skilled in the art that equivalent changes in form and detail may be made therein without departing from the true spirit and scope of the invention, and that the scope of the present invention is to be limited only to the claims except as precluded by the prior art. Moreover, the invention as disclosed herein may be suitably practiced in the absence of the specific elements which are disclosed herein.

What is claimed is:

1. A divider insert for a baking pan comprising a horizontal centerpiece which bicepts two parallel equidistant sides at the center of the parallel equidistant sides.

2. The divider insert of claim 1, wherein the insert is sized to accommodate a baking pan, and the height of the divider insert is appropriate to accommodate the depth of the baking pan.

3. The divider insert of claim 2, wherein the height of the divider measures approximately one and one quarter inches.

4. A divider insert for a baking pan comprising an insert in the form of a ladder having two rungs, wherein the rungs are parallel to each other and, which rungs are perpendicular to two parallel equidistant sides.

5. The divider insert of claim 4, wherein the insert is sized to accommodate a baking pan, and the height of the divider insert is appropriate to accommodate the depth of the baking pan.

6. The divider insert of claim 4, wherein the height of the divider measures approximately one and one quarter inches.

7. A divider insert for a baking pan comprising at least a first divider and a second divider, wherein the dividers are slotted and the cut of the slot extends from one edge of the divider to half way through the height of the divider, and wherein the slot on the first divider can correspond to the slot on the second divider so the first divider is perpendicularly oriented to the second divider.

8. The divider insert of claim 7, further comprising a series of spaced apart slots and the cut of the slots extends from one edge of the divider to half way through the height of the divider.

9. The divider insert of claim 8, further comprising multiple dividers to create multiple servings.

10. The divider insert of claim 9, wherein the multiple inserts create servings numbering 2, 3, 4, 6, 8, 9, 12, 24 and 24 slots.
